(19) United States
(12) Patent Application Publication
(10) Pub. No.: US 2019/0213845 A1
(43) Pub. Date: Jul. 11, 2019

(54) Anti-Shimming Deviice, Reader, Method and Kit

(71) Applicant: TMD Holding B.V., Blaricum (NL)

(72) Inventors: Cornelis Johannes Goedee, Houten (NL); Marina Helena De Jongh, Houten (NL)

(21) Appl. No.: 15/999,739

(22) PCT Filed: Feb. 20, 2017
(86) PCT No.: PCT/NL2017/050102

§ 371 Date: Aug. 20, 2018

(30) Foreign Application Priority Data
Feb. 18, 2016 (NL) 2016283

(51) Int. Cl. G07F 19/00; G06K 13/08

(52) U.S. Cl. CPC G07F 19/2055; G06K 13/0887

(57) ABSTRACT

The present invention relates to an anti-shimming and/or anti-skimming device for placement inside of a transaction card reader with a transaction card insertion slot, the device comprising: a card insertion space limiter for limiting the insertion space of the card during insertion thereof into the transaction card reader, a top side space limiter limiting the insertion space at the top side of the card, a bottom side space limiter limiting the insertion space at the bottom side of the card, wherein the device is placeable on the inside of a transaction card reader for receiving the transaction card between the top side space limiter and the bottom side space limiter adjacent to card reading contacts of the transaction card reader.

The present invention relates to an anti-shimming and/or anti-skimming device for placement inside of a transaction card reader with a transaction card insertion slot. Furthermore, the present invention relates to a transaction card reader comprising an anti-shimming and or anti-skimming device according to the present invention. Furthermore, the present invention relates to a method for placing an anti-shimming and or anti-skimming device according to the present invention. Furthermore, the present invention relates to a kit comprising an anti-shimming and/or anti-skimming device according to the present invention with a caliber for correct orientation of the anti-shimming and/or anti-skimming device relative to a pre-determined card reader.

In the real world, several types of card readers are known to be able to interact with the transaction cards. Since transaction cards comprise transaction cards with magnetic stripes and/or data chips. Initially, for use with cards having a magnetic stripe only, a reading device was used with a motorized transport for transporting the magnetic stripe along a reading head capable of reading out the information stored on the magnetic stripe. A large portion of the present day card readers still possess this function, but it is also integrated in non-motorized dip readers. In this case, a recess is present for inserting and taking out of the card next to a non-recessed part comprising the magnetic stripe reading head. Also card readers exist that only provide chip reading capabilities.

Cards exist that have only a chip, cards exist that have both a chip and a magnetic stripe, and cards exist that only have magnetic stripes, even at present times.

Unauthorized reading of a magnetic stripe is commonly referred to as skimming. In the case of skimming, a parallel reading head is placed on or in the card reader, for which the main requirement is that the magnetic stripe of the card stripe is guided along that parallel reading head such that the information on the magnetic stripe can be read out. Unauthorized reading of chips is commonly referred to as shimming, because it requires placement of contacts and/or circuitry between the chip of the card and the contacts of the card reader. The shimming device performs a form of a “man in the middle attack” by means of monitoring information transfer between the reading head of the card reader and the chip.

In order to provide limitations to the possibilities of skimming and/or shimming, the present invention provides an anti-shimming and/or anti-skimming device for placement inside of a transaction card reader with a transaction card insertion slot, the device comprising:

a card insertion space limiter for limiting the insertion space of the card during insertion thereof into the transaction card reader,

a top side space limiter limiting the insertion space at the top side of the card,

a bottom side space limiter limiting the insertion space at the bottom side of the card,

wherein the device is placeable on the inside of a transaction card reader for receiving the transaction card between the top side space limiter and the bottom side space limiter adjacent to card reading contacts of the transaction card reader.

A main purpose of the top side space limiter and the bottom side space limiter is to limit available space for a shimming device to be inserted into the inside of the card reader. Even with the most accurately standard compliant transaction card readers, it has been possible to insert a shimming device with shimming contacts to be located at the card contacts of the card reader. However, a shimming device also requires electronic circuitry. Such electronic circuitry is located in the adjacency of the card contacts of the card readers, where there is enough vertical space to arrange such chip circuitry. The present invention has as a main advantage the capability of blocking such space for the circuitry of the shimming device, especially or preferably adjacent to the card contacts in the card reader. Thereby, the anti-shimming and/or anti-skimming device according to the present invention prevents successful placing of an shimming device next to the card reading contacts of the card reader. The device basically provides an introduction height, the insertion space also indicated as a corridor or channel for passing through the card into the card reader. The introduction height limits the space in which a shimming device and or skimming device could be counterfeitly arranged for obtaining card data.

According to a first preferred embodiment, in the anti shimming and/or anti skimming device the top side space limiter and the bottom side space limiter are each mounted in the transaction card reader by means of fixation means related to the resp. top side space limiter and bottom side3 space limiter. This provides advantages in certain embodiments of card readers in which the device is applied.

The anti-shimming and/or anti-skimming device comprises connection means for providing a relative arrangement between the top side space limiter and the bottom side space limiter, the connection means preferably being embodied as a member between the top side space limiter and the bottom side space limiter. This connection member provides stability to the combination of the top side space limiter and bottom side space limiter. Further preferably, the card insertion space limiter is generally U-shaped, the U-shape preferably formed by the top side space limiter, the bottom side space limiter with the connection means forming the connecting bottom of the U. In such embodiments, the card insertion space limiter can be produced in a cost-effective manner in a stable manner. A baseplate can be formed into such parts by generally known deformation methods.

In an embodiment in which the connection means have height higher than the introduction slot for carts of the card reader, removal of the device by a person wanting to place a shimming device from a transaction cards reader is effectively inhibited.

Preferably, the device comprises fixation means for providing a fixation of the device relative to the transaction card reader. Such fixation means inhibit removal of the device. Furthermore, such fixation means provide a correct orientation of the device relative to the transaction card reader. This is especially of relevance in combination with a feature, to be described below, allowing access of cards with embossing.

A preferable embodiment of such fixation means comprises adhesive means for affixing a space limiter, preferably the bottom side space limiter to the transaction card reader. An alternative for such fixation means comprises extensions, preferably embodied as pretensioned metal extensions, and/or barbs for affixing and or arranging the anti-shimming and or anti-skimming device relative to the transaction card reader.

According to a further preferred embodiment, a card introduction height, preferably indicated as a corridor or channel, between the top side space limiter and the bottom side space limiter has the thickness of a standardized transaction card plus a tolerance for comfortable card insertion. Such height effectively inhibits combined insertion of a shimming device together with a transaction card. This means that even when a shimming device has been introduced into the transaction card slots in which a device according to the present invention is mounted, it will be impossible to also insert a transaction card as the height of the limited space prevents such combination.

In a further preferred embodiment, the top side space limiter provides pass through means for allowing embossed characters, preferably standardized embossed characters to be passed along the top side space limiter. A large number of transaction cards, especially credit cards, are provided with embossed characters indicating the name of the holder, and mostly an expiration date, amongst other information. The present embodiments allows for continuous use of such cards with embossing in combination with the present invention. Preferably, such pass through means are embodied by ridges or fins reaching into the insertion space between the top side space limiter and the bottom size space limiter. In this case, the top of the ridges or fins will reach the body of the card, effectively embodying the card body reaching part of the card limiter at that side.

Further preferably, the pass through means are formed from a pass through means plate, preferably reaching through pass through means plate slots in the top side space limiter. This embodiment allows for both a favorable manufacturing and a high reliability of use in combination with embossed letters. In case the ridges or fins are created by cutting and bending, the bending curve will not reach the card you to the thickness of the top side space limiter. This will be readily apparent when studying a preferred embodiment.

A deflection ridge forms a preferred embodiment of means to both assist in reliable sliding of the transaction card and preventing tampering with the device according to the present embodiment arranged at a transaction card insertion slot side thereof, reaching away from the transaction card insertion slot. It would be preferable for a person wanting to place a shimming device to remove the device. This present embodiment prevents that an object, such as a knife or a screwdriver can reach the non-card side of the top side space limiter and/or the bottom side space limiter.

According to a further preferred embodiment, the present invention provides an anti-shimming and/or anti-skimming device comprising a mounting assembly for mounting thereof relative to the card reader. By means of such mounting assembly, several advantages can be achieved. A first of such advantages is that aspects, such as rigidity, and or the orientation relative to the transaction cards reader can be made relatively more reliable in a simple manner. Furthermore, adjustments to specific cards readers and the made by or extended to such mounting assembly.

Preferably, the mounting assembly comprises adjustment means for adjusting the distance between the top side space limiter and the bottom side space limiter, preferably embodied as adjustment screws. By means of such adjustment means, the reliability of the device can be improved, especially a combined insertion of a shimming device and a transaction card can be more reliably prevented. Also mounting to specific instances of card readers can be made more easy and or more reliable by providing the mounting assembly with mounting means adapted to a predefined card reader.

A further preferred embodiment provides an anti-shimming and or anti-skimming device in which the bottom side space limiter comprises at least one barrier, preferably embodied as a ridge, the top of the barrier defining the top side of the bottom side space limiter, preferably defining bottom of the introduction height against which a card being inserted is stopped. This provides a clear stop as a bump to the user if notice is to be taken due to a blocking object in the corridor. Also, with such a bump it is prevented that a card gradually gets stuck, such that a user keeps pushing as there is no clear reason to stop or be alarmed by the gradually impacting obtrusion.

Preferably, the bottom side space limiter comprising at least one card urging member for urging the card, preferably a bent card, towards the top side of the barrier, preferably at least one per barrier. The urging member thus prevents stopping by the barrier of cards that are bent and not any obtrusion creates the bump.

Further preferably, the urging member is embodied as a firmly biased ball protruding upward out of a bottom part of the bottom side space limiter in front of the barrier as seen in the direction of inward movement of the card into the card reader. Also, the at least one barrier is arranged adjacent to the chip card reading head of the card reader, preferably in a line just in front of this head, further preferably besides this head.

Further preferably, the top side space limiter is provided with bumps toward the card side, preferably or recesses opposite to the card side providing, preferably a bottom side directed towards the card providing a top side of the introduction height.

A further aspect of the present invention is a transaction card reader provided with a suitably dimensioned anti-shimming and/or anti-skimming device according to the present invention. The combination provides a very reliable prevention of shimming.

A further aspect of the present invention is a method for placing an anti-shimming and/or anti-skimming device according to one or more of the preceding claims in a transaction card reader, the method comprising steps of:

placing the anti-shimming and/or anti-skimming device in a card insertion area of the card reader,

orienting the anti-shimming and/or anti-skimming device in an orientation suitable for uninterrupted reception of the transaction card,

fixing the orientation of the anti-shimming and/or anti-skimming device in the said orientation.

Advantages of such a method comprise that the device is placed in a best possible orientation relative to the transaction card reader.

Preferably, the method comprises steps of adjusting the distance between the top side space limiter and the bottom side space limiter such that the distance is equal to the body of a standardized transaction card plus a tolerance for comfortable card insertion.

Further preferable, the method comprises steps for adapting the orientation for correct reception of embossed characters, preferably standardized embossed characters of the transaction card. Steps of using an orientation caliber for adjusting the orientation relative to the card reader provide a further simplification of execution of such a method.

A further aspect of the present invention relates to a kit comprising an anti-shimming and/or anti-skimming device according to the present invention and a caliber for correct orientation of the anti-shimming and/or anti-skimming device relative to a predetermined card reader.

Further advantages, features and details of the present invention will be further elucidated on the basis of a description of one or more embodiments with reference to the accompanying figures.

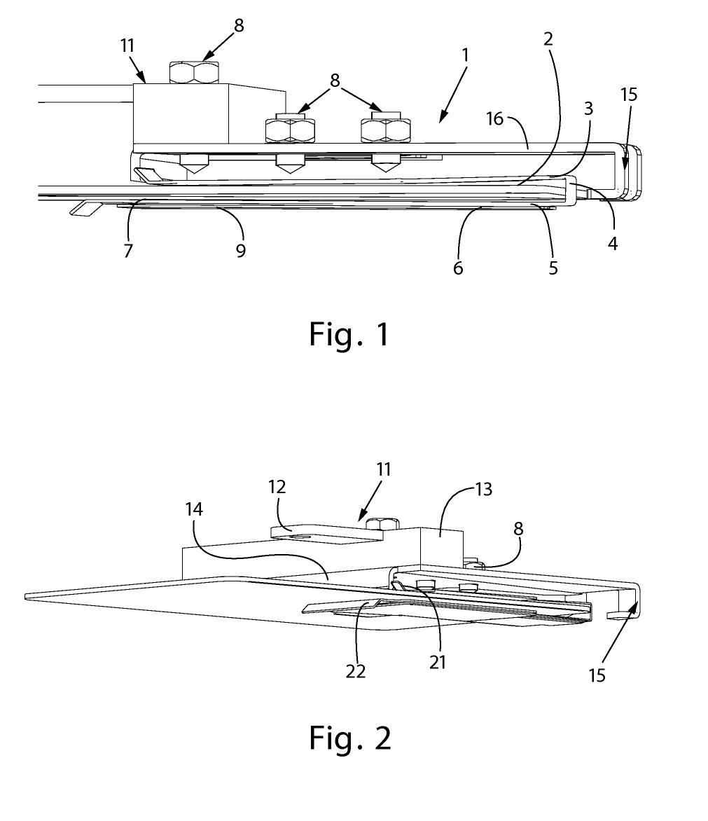

FIG. 1 shows a first preferred embodiment according to the present invention in a side view.

FIG. 2 shows a further view of the preferred embodiments.

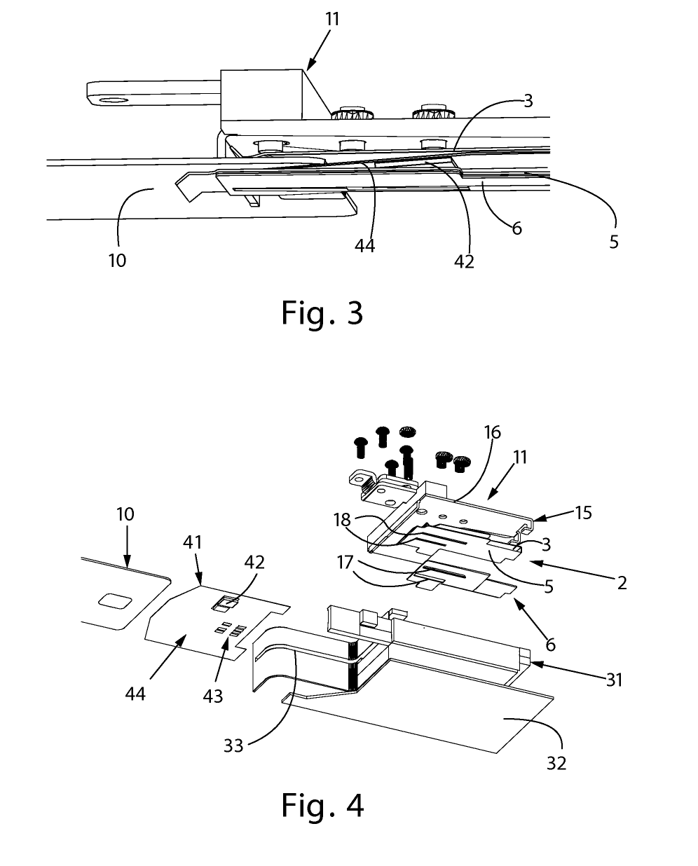

FIG. 3 shows a detail of the preferred embodiments with an inserted shimming device blocking insertion of a card.

FIG. 4 shows an exploded view of the embodiment according to the present invention, with a card reader, a shimming device and a card.

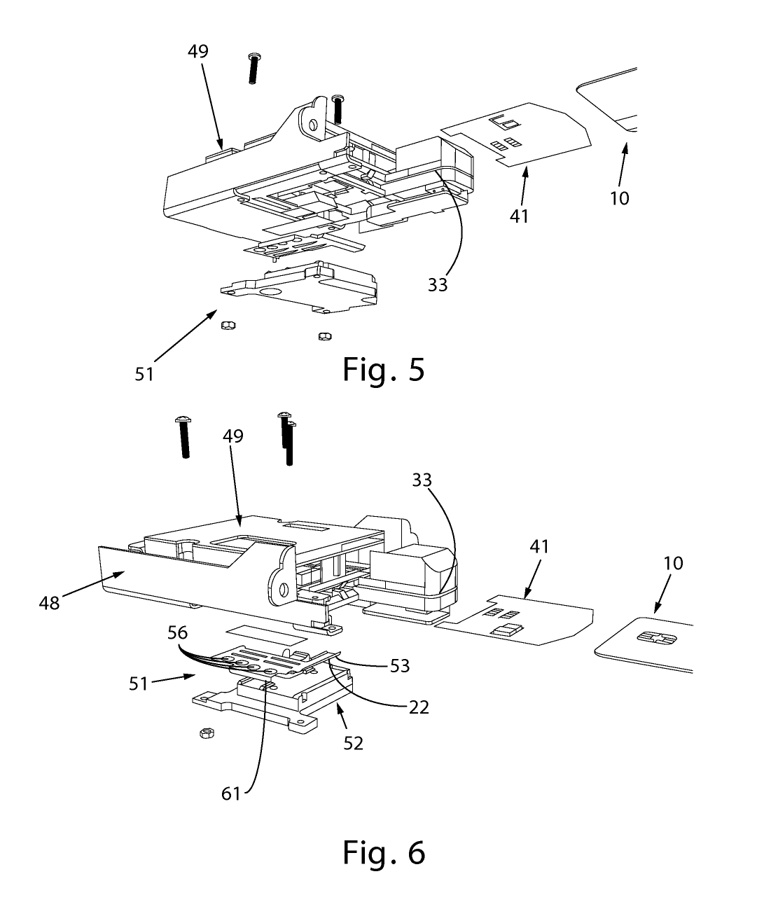

FIGS. 5-8 show a further preferred embodiment according to the invention in several views, preferably in a predetermined card reader such as the NCR self serv® card reader.

FIG. 9 shows a caliber according to a further preferred embodiment preferably being used while placing and correctly arranging and orienting a top side space limiter.

FIG. 1 shows a first preferred embodiment according to the present invention. In this preferred embodiment, the anti-shimming and/or anti-skimming device 1 comprises a generally U-shaped card insertion space limiting device 2. A bottom side thereof is formed by plate 3, a back side thereof is formed by plate 4 and a top side thereof is formed by plate 5. The definition of bottom and top is relative to the location on the card of the chip contacts and the embossing of the card as understood by the end user. The end user will interpret the top side as the side of the chip contacts and the embossing. For the purpose of this description, the terms top and bottom are used accordingly. However, top and bottom good be interpreted the other way around depending on the way the device is looked upon. In the drawing, the top side is the bottom side.

The top plate 5 comprises two slits 18 for accepting ridges 17 of the ridge plate 6. The top plate 5 is preferably welded to the ridge plate 6. The ridges allow for space between the top plate 5 and the top of the ridges for receiving the embossed letters on the card.

A mounting device 11 is provided for supporting the space limiting device 2. The mounting device 11 comprises a support bar 13 connected to an extension 12 for accepting a mounting screw. Connected to the support bar 13 a is a blade member 16 that in its turn is connected to a hooking part 15 for holding on to a relevant part of the transaction card reader 31 having an integrated circuit board 32 and a card receiving slot 33.

A shimming device 41 as used in the real world is shown as an example. Such a shimming device comprises a sheet like body 44, contacts 43 and integrated circuits 42. The present invention prevents both the space for the sheet like body 44 and the integrated circuits 42 to some extent.

As can be seen in FIG. 3, when a shimming device would be inserted in a card reader provided with an anti-shimming and/or anti-skimming device according to the present invention, it would be impossible to insert a card. One reason that it is impossible to insert the cards, is that the integrated circuits 42 of the shimming device will prevent insertion of the card 10 in the insertion space as defined by the limiters. Also the thickness of the sheet like body 44 will prevent the card from reaching the card reading contacts of the card reader. Especially the thickness of the integrated circuits 42 of the shimming device would be pushed in the space required by the card by the top side space limiter and or the bottom side space limiter when such a shimming device would be inserted into a card reader equipped with a device according to the present invention.

The mounting device 11 is equipped with adjustment screws 8 for adjusting the distance between the top side space limiter and the bottom side space limiter, by pushing the bottom side space limiter towards the top side space limiter.

It is especially envisaged in this embodiment, to glue the top side space limiter, by means of adhesive or double-sided tape 9, to a corresponding surface of the transaction card reader. Shims are considered in case the distance to such corresponding surface do so requires. Therefore, the device is fixed to the transaction card reader by means of such adhesive or double-sided tape 9. Consequently, the adjustments by means of the screws 8 finalize the orientation relative to the transaction card reader. Such fixation also prevents removal or tampering with the device.

The bent edges 22 and 21 of the respective top side space limiter and bottom side space limiter prevent grip by a screwdriver or a knife from the card insertion slot of the transaction cards reader. Also, the bent edge 14 of the plate 16 prevents access to the bent edge 21 of the bottom side space limiter.

Depending on the transaction cards reader, such features can be made by a skilled person within the scope of the present disclosure.

The preferred embodiment according to FIGS. 5-8 is an anti-shimming and/or anti-skimming device comprising a top side space limiter and bottom side space limiter providing a corridor with a generally predetermined introduction height for introducing a card, thus preventing that either a shimmer or skimmer can be placed or preventing introduction of the card when a shimmer or skimmer is placed in the introduction height.

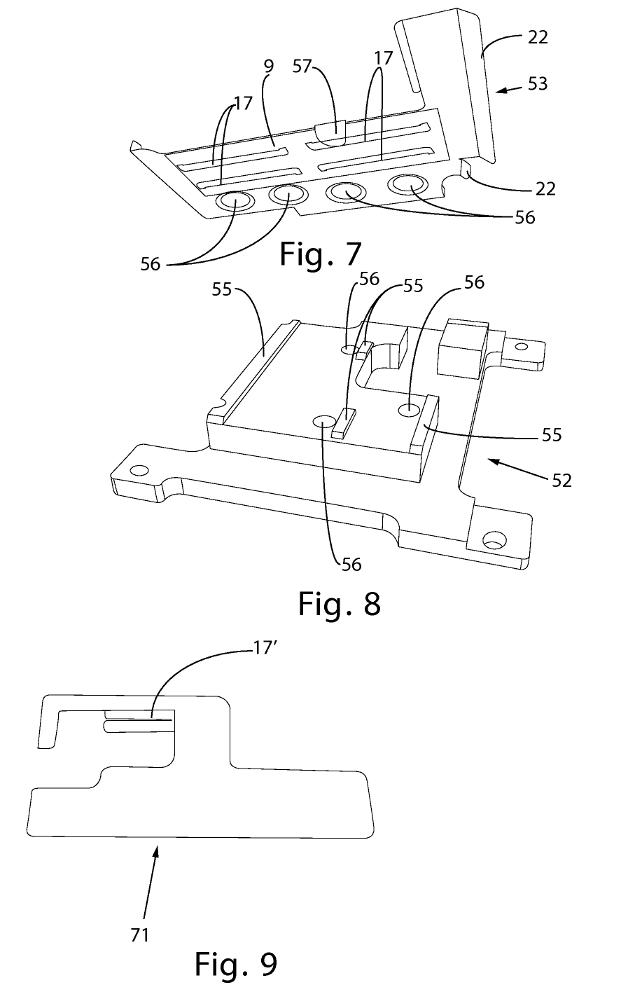

FIG. 5 is an exploded perspective view generally from the underside and FIG. 6 is an exploded perspective view generally from the top side. FIG. 7 is a detail of the top side space limiter of this preferred embodiment and FIG. 8 is a detail of a bottom side space limiter according to this preferred embodiment. A bracket 48 is provided for the card reader 49.

In the card reader, the bottom space limiter is arranged under the top space limiter with a space between them to create a limited introduction height for a transaction card.

The bottom side space limiter is 52 is embodied as a metal plate thick enough at portions to hold the balls being biased by a spring force from the underside. The balls are arranged generally in front of the barriers 55 providing a stop function to the card if a blocking device, such as a shimmer or skimmer is placed in the card reader between de bottom side space limiter and the top side space limiter. If such an obtrusion is present, the card will be pushed downwardly to be stopped by the first barrier it touches after being pushed downwardly.

The purpose of the balls is to guide a bent card over the barrier when the card would hit the barrier because of the bend. Thus the upward strength of the ball is quite firm to prevent blocking by such a bent card, yet not enough to prevent a straight or bent card from hitting the barrier if the card is moved towards the barrier by matter of the shimmer or skimmer. An advantage thereof is that the user is experiencing the stop as a hard bump and that the card will then stop. If the bump would be gradual, the card could gradually be pushed further until it would be stuck beyond manual removal, which is an even more disturbing effect than the bump like stop.

The top side space limiter f53 is somewhat more similar to that of the previous embodiment. It provides ridges 17 for allowing embossed letters of the card in between those.

The caliber according to FIG. 9 provides guiding slots for the ridges 17 of the top space limiter in order to align those during placement in the card reader and before gluing the top space limiter to a corresponding surface of the card reader.

To explain further, a method for placement of the anti shimming or anti skimming device according to this embodiment is provided. Remove the card reader. Clean the DIP card reader base with a surface cleaning towel on picture). Wait until the cleaning liquid residue is completely dry before attaching the top side space limiter.

The Inner plate is be aligned with the placement caliber. The Placement Caliber has an exact fit into the card reader, its guiding slot guides a rib of the Inner plate during the installation and pasting.

The placement caliber hook pushes the top side space limiter against the rear of the card reader during placement. The ribs 17 fit exactly in the guiding slot of the placement caliber. Four islands and ribs are available to fill up the spaces any electronics can be stored. The caliber is used to open up the dust shutter of the card reader during placement. Push the placement caliber into the card reader until the shutter opens (1). Do not push the Placement Caliber any further. Take the top side space limiter and insert the pink strip sheet through the shutter and guide it underneath the placement caliber (2). Slide the top side space limiter “underneath” the plastic lug above the contact block in the direction of the arrows. Take notice that the contact block is unaffected by the top side space limiter during installation.

Press on the top side space limiter so that it can slide under the plastic lug. Slide the top side space limiter now against the back of the card reader base. Pull the caliber backwards until the shutter closes in order to place the top side space limiter in the correct starting position for the paste process.

Aligning the top side space limiter is performed as follows. Push the caliber into the card reader while pressing down the top side space limiter. Check, while sliding the caliber, if the guiding rib of the top side space limiter fits into the caliber guiding slot 17′. If not, move the top side space limiter until it does. Check if the rib fits into the slot). If aligned correctly the top side space limiter cannot be moved. Give pressure on the top side space limiter to keep the top side space limiter in position (1). Give pressure on the caliber (71). Remove the adhesive protection sheet. Check and re-check if the rib is still in place within the Placement Caliber (71).

For placing the bottom side space limiter in a card reader the set of screws included in the kit is required. To secure the bottom side space limiter to the card reader and the metal bracket fasteners, such as screws are provided. Take the bottom side space limiter and place this over the protruding screws and secure these with M3 nuts included in the kit. Place M2,5 screw in the spare hole on the top of the CPP4-HO1 top plate to secure it to the card reader. Insert a test card to assure a normal guidance of the customer card. Re-install the card reader. Power on the ATM and perform several card reader tests.

The present invention is described in the foregoing on the basis of several preferred embodiments. Different aspects of different embodiments can be combined, wherein all combinations which can be made by a skilled person on the basis of this document must be included. These preferred embodiments are not limitative for the scope of protection of this document. The rights sought are defined in the appended claims.

1.-26. (canceled)

27. An anti-shimming and/or anti-skimming device for placement inside of a transaction card reader with a transaction card insertion slot, the device comprising:
a card insertion space limiter for limiting the insertion space of the card during insertion thereof into the transaction card reader,
a top side space limiter limiting the insertion space at the top side of the card,
a bottom side space limiter limiting the insertion space at the bottom side of the card,
wherein the device is placeable on the inside of a transaction card reader for receiving the transaction card between the top side space limiter and the bottom side space limiter adjacent to card reading contacts of the transaction card reader.

28. The anti-shimming and/or anti-skimming device according to claim 27, wherein the top side space limiter and the bottom side space limiter are each mounted in the transaction card reader by means of fixation means related to the resp. top side space limiter and bottom side space limiter.

29. The anti-shimming and/or anti-skimming device according to claim 27, comprising connection means for providing a relative arrangement between the top side space limiter and the bottom side space limiter, the connection means preferably being embodied as a member between the top side space limiter and the bottom side space limiter.

30. The anti-shimming and/or anti-skimming device according to claim 27, wherein the card insertion space limiter is generally U-shaped, the U-shape preferably formed by the top side space limiter, the bottom side space limiter with the connection means forming the connecting bottom of the U.

31. The anti-shimming and/or anti-skimming device according to claim 27, comprising fixation means for providing a fixation of the device relative to the transaction card reader.

32. The anti-shimming and/or anti-skimming device according to claim 31, wherein the fixation means comprise adhesive means for affixing a space limiter, preferably the bottom side space limiter to the transaction card reader.

33. The anti-shimming and/or anti-skimming device according to claim 31, wherein the fixation means comprise extensions, preferably embodied as pretensioned metal extensions, and/or barbs for affixing and or arranging the anti-shimming and or anti-skimming device relative to the transaction card reader.

34. The anti-shimming and/or anti-skimming device according to claim 29, wherein the connection means have height higher than the introduction slot for cards of the card reader.

35. The anti-shimming and/or anti-skimming device according to claim 27, providing an introduction height between the top side space limiter and the bottom side space limiter of the thickness of a standardized transaction card plus a tolerance for comfortable card insertion.

36. The anti-shimming and/or anti-skimming device according to claim 27, wherein the top side space limiter provides pass through means for allowing embossed characters, preferably standardized embossed characters to be passed along the top side space limiter.

37. The anti-shimming and/or anti-skimming device according to claim 36, wherein the pass through means are embodied by ridges or fins reaching into the insertion space between the top side space limiter and the bottom size space limiter.

38. The anti-shimming and/or anti-skimming device according to claim 36, wherein the past through means are formed from a pass through means plate, preferably reaching through pass through means plate slots in the top side space limiter.

39. The anti-shimming and/or anti-skimming device according to claim 27, wherein the top side space limiter and or the bottom size space limiter comprises a deflection ridge arranged al a transaction card insertion slot side thereof, reaching away from the transaction card insertion slot.

40. The anti-shimming and/or anti-skimming device according to claim 27, comprising a mounting assembly for mounting thereof relative to the card reader.

41. The anti-shimming and/or anti-skimming device according to claim 38, wherein the mounting assembly comprises adjustment means for adjusting the distance between the top side space limiter and the bottom side space limiter, preferably embodied as adjustment screws.

42. The anti-shimming and/or anti-skimming device according to claim 27, wherein the bottom side space limiter comprises at least one barrier, preferably embodied as a ridge, the top of the barrier defining the top side of the bottom side space limiter, preferably defining bottom of the introduction height against which a card being inserted is stopped.

43. The anti-shimming and/or anti-skimming device according to claim 42, the bottom side space limiter comprising at least one card urging member for urging the card, preferably a bent card, towards the top side of the barrier, preferably at least one per barrier.

44. The anti-shimming and/or anti-skimming device according to claim 43, the urging member being embodied as a firmly biased ball protruding upward out of a bottom part of the bottom side space limiter in front of the barrier as seen in the direction of inward movement of the card into the card reader.

45. The anti-shimming and/or anti-skimming device according to claim 42, wherein the at least one barrier is arranged adjacent to the chip card reading head of the card reader, preferably in a line just in front of this head, further preferably besides this head.

46. The anti-shimming and/or anti-skimming device according to claim 42, wherein the top side space limiter is provided with bumps toward the card side, preferably or recesses opposite to the card side providing, preferably a bottom side directed towards the card providing a top side of the introduction height.

47. A transaction card reader provided with a suitably dimensioned anti-shimming and/or anti-skimming device according to claim 27.

48. A method for placing an anti-shimming and/or anti-skimming device according to claim 27 in a transaction card reader, the method comprising steps of:
placing the anti-shimming and/or anti-skimming device in a card insertion area of the card reader,
orienting the anti-shimming and/or anti-skimming device in an orientation suitable for uninterrupted reception of the transaction card,
fixing the orientation of the anti-shimming and/or anti-skimming device in the said orientation.

49. The method according to claim 48, comprising the steps of adjusting the distance between the top side space limiter and the bottom side space limiter such that the distance is equal to the body of a standardized transaction card plus a tolerance for comfortable card insertion.

50. The method according to claim 48, wherein the orientation is adapted for correct reception of embossed characters, preferably standardized embossed characters of the transaction card.

51. The method according to claim 48, comprising the steps of using an orientation caliber for adjusting the orientation relative to the card reader.

52. A kit comprising an anti-shimming and/or anti-skimming device according to claim 27 and a caliber for correct orientation of the anti-shimming and/or anti-skimming device relative to a predetermined card reader.
